(19) United States
(12) Patent Application Publication
(10) Pub. No.: US 2015/0073913 A1
(43) Pub. Date: Mar. 12, 2015

(54) SYSTEM AND METHOD OF IDENTIFYING AND SENDING CONTENT

(71) Applicant: Stephen Whitney, (US)

(72) Inventor: Stephen Whitney, Dublin (IE)

(73) Assignee: MasterCard International Incorporated, Purchase, NY (US)

(21) Appl. No.: 14/022,484

(22) Filed: Sep. 10, 2013

(51) Int. Cl. G06Q 30/02; G06Q 30/06

(52) U.S. Cl. CPC G06Q 30/0269; G06Q 30/0633
USPC 705/14.66

(57) ABSTRACT

A system, method, and computer-readable storage medium configured to locate and send content to a consumer based on the consumer's interest in certain products or services.

### BACKGROUND

1. Field of the Disclosure

Aspects of the disclosure relate in general to electronic information sharing. Aspects include a method and system of identifying and sending content to a consumer, and more particularly, to a network-based system and method that provides a computer-related platform to receive an indication of interest in a product from a consumer, locating content related to the product of interest for the consumer, and sending the located content to the consumer.

2. Description of the Related Art

Many companies conducting product sales on the Internet use algorithms in an attempt to predict purchase behavior of online consumers. These predictions generally take two forms. First, if an online consumer uses the Internet to purchase an item on a recurring basis—for example, laundry detergent—a company tries to predict the frequency of the purchase to remind the online consumer when they're likely to need to re-purchase the item. Second, a company links together items that are usually purchased together. For example, if an online consumer purchases baby bottles, a company suggests an additional purchase of baby formula to use in the bottles.

These existing methods are directed at driving additional purchases from online consumers. However, most of the time an average Internet user spends on the Internet is not spent in commerce; rather, the average user spends a majority of their time on the Internet viewing content. As used herein, “content” means anything viewable on the Internet that is not directly related to online commerce (i.e., not directly related to the purchasing products and services over the Internet).

### SUMMARY

Embodiments include a system, method and computer-readable medium to identify and send content to a consumer. Notification that a consumer has indicated interest in an identified product is received. In some embodiments, this notification is received once the consumer has added a product to their ‘wish list’ with an online merchant. A computer processor locates in a content database content associated with the identified product. Without request from the consumer, a message is sent containing at least a portion of the content located by the computer processor and associated with the identified product.

### BRIEF DESCRIPTION OF THE DRAWINGS

FIG. 1A is a simplified block diagram of an exemplary system embodiment configured to identify and send content to a consumer.

FIG. 1B is a simplified block diagram illustrating communications between a processor and a consumer in an exemplary embodiment.

FIG. 2 is a flow diagram of a process for identifying and sending content to a consumer in accordance with certain embodiments.

FIG. 3 is a flow diagram of a process for identifying and sending newly received content to a consumer in accordance with certain embodiments.

FIG. 4A is a simplified block diagram of an exemplary system embodiment configured to identify and send content to a consumer.

FIG. 4B is a simplified block diagram illustrating communications between a processor and a consumer in an exemplary embodiment.

FIG. 5 is a flow diagram of a process for identifying and sending content to a consumer in accordance with certain embodiments.

### DETAILED DESCRIPTION

This description of the exemplary embodiments is intended to be read in connection with the accompanying drawings, which are to be considered part of the entire written description.

Although the exemplary embodiments provided herein involve a “product,” it would be understood by one of skill in the art that the present disclosure could easily be extended to all types of online purchases, such as those for services and other intangible goods. The present disclosure should thus be read with the understanding that “product” may include services and intangible goods able to be purchased online.

An aspect of the disclosure includes realizing that a process to identify and send content to a consumer based on a prediction may be useful to the consumer.

One aspect of the disclosure includes the assumption that a consumer is likely to enjoy content associated with products in which the consumer is interested. As is further disclosed below, the present disclosure requires: (1) a determination of a consumer's interest in a product, (2) locating content associated with that product, and (3) sending the located content to the consumer. This process is performed based on the assumption, stated above, that the located content associated with a known product-of-interest will likely be of interest to the consumer. If the content is of interest to the consumer, then the consumer is more likely to view and enjoy the content.

The content engine described herein to identify and send content to a consumer may be provided as a stand-alone service, for which the consumer would register, or as a complimentary service by, for example, an online merchant or online financial services institution with which the consumer is already registered.

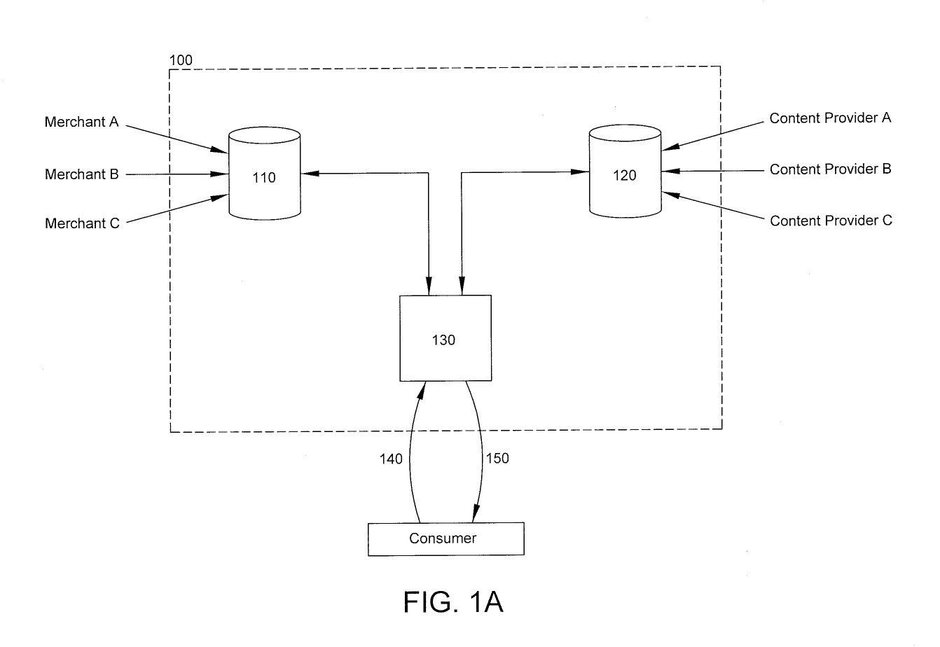

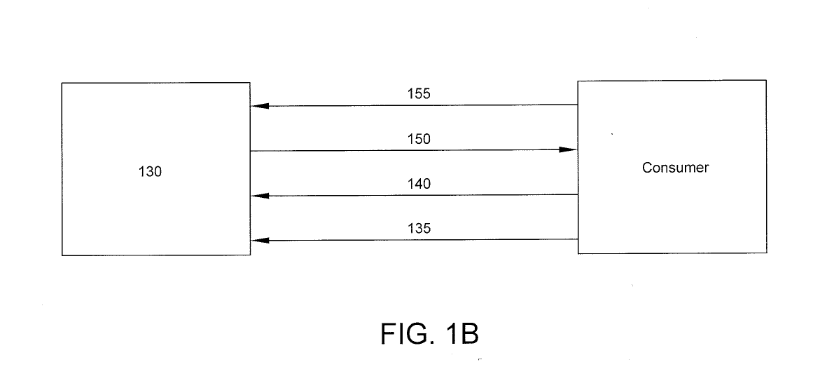

FIG. 1A is a block diagram of an exemplary system in accordance with some embodiments of the present disclosure. FIG. 1A illustrates a content engine 100 comprising a product database 110, a content database 120, and a processor 130.

Product database 110 is configured to receive product information from at least one merchant. Product information may include product name, description, price, dimensions, features, shipping weight, location, manufacturer, availability, merchant offering the product for sale and the like. Product information is stored in product database 110, which is accessible to processor 130.

As an illustrative example, which is not limiting on the present disclosure and will be used throughout this description, suppose a customer is interested in a certain type (brand or model) of digital camera. In the present disclosure, information regarding this type of digital camera is collected into the product database 110 such that the content engine 100 has information available regarding which online merchants are offering the digital camera for sale and under what terms and conditions.

Content database 120 is configured to receive content information from at least one content provider. A content provider is generally an entity that publishes content on the Internet, but may also include television and radio broadcasters, print media, and other entities which provide information to the public. Content providers populate content database 120 with information regarding the content, including the type of content (online publication, television, online video, radio, print media, and the like), a brief description of the content, timing of the content (date/time of publication, transmission, viewing), products associated with the content, and the strength of association between the content and the product. Content is stored in content database 120, which is accessible to processor 130.

With specific regard to the strength of association between content and a product, the content provider may provide this strength of association, or processor 130 may determine the strength of association. The strength of association may be implemented as a scale, for example from 0 to 100, wherein a high degree of association receives a higher score on the scale. For example, content such as an article reviewing a product would receive a higher strength of association score than a television show making a passing reference to the product. In some embodiments, the strength of association is provided by the content provider and adjusted for consistency across all content by the content engine 100. As is discussed below, the strength of association may be used in some embodiments to filter content prior to sending a content message 150.

Continuing with the example of a digital camera, content associated with the digital camera could include (1) a consumer advocate's review of the digital camera, posted online; (2) a guide on how to use the digital camera, created by the camera's manufacturer and posted online or printed; and (3) a television show that will feature the digital camera, either directly or indirectly. Each provider of the content mentioned here could populate the content database 120 with information regarding the content.

Processor 130 is a computer processor that includes a non-transitory computer readable medium encoded with data and instructions for the various processing steps required in the present disclosure. Processor 130 is configured to communicate, either directly or via a network interface, with product database 110, content database 120, and the consumer.

FIG. 1A illustrates the basic interaction between content engine 100 and a consumer. Content engine 100 receives indication 140 from the consumer, and sends content message 150 to the consumer. A network interface connects the content engine 100 with the consumer. Additional detail regarding the communications between processor 130 and the consumer is provided in FIG. 1B.

Indication 140 is a consumer's indication of interest in a product. In some embodiments, indication 140 is received when a consumer adds a product to a ‘Wish List’—a list available with many online merchants that allows a consumer to track products the consumer would like to purchase. The present disclosure posits the act of adding a product to a ‘Wish List’ is a direct indication of a consumer's interest in a product. Content engine 100 is configured to receive, via a network interface, indication 140 once the consumer has added a product to their ‘Wish List.’

In other embodiments, indication 140 is received in the form of a consumer's purchase history. A consumer's purchase history may be obtained directly from the consumer, from the consumer's web browser using a purchase tracker, from a third party merchant, or from a third party financial service, such as a credit card company or online payment system provider. Purchase history can be reviewed by processor 130 to evaluate a consumer's predicted level of interest in various content, and to identify products of potential or probable interest to the consumer.

In some embodiments, indication 140 is received in the form of a consumer's Internet browsing history. Browsing history can include a list of websites visited by a consumer, the duration of viewing each website, a list of products researched or viewed online, a list of advertisements viewed or selected during browsing, and the duration of viewing each product or advertisement. Browsing history can be reviewed by processor 130 to evaluate a consumer's predicted level of interest in various content, and to identify products of potential or probable interest to the consumer.

In some embodiments, indication 140 is received in the form of social media history. Social media history can include communications made by a consumer via social media, websites viewed or selected while using social media, advertisements viewed or selected while using social media, products or content a consumer indicates interest in or approval of via social media (i.e., selecting the ‘like’ function on a product's website or sharing content via social media), and content viewed, selected, or shared while using social media. Social media history can be reviewed by processor 130 to evaluate a consumer's predicted level of interest in various content, and to identify products of potential or probable interest to the consumer.

Returning to the example of a digital camera, an indication of consumer interest in the camera may be received (1) when the consumer adds the digital camera to the consumer's ‘Wish List,’ (2) from the consumer's purchase history that shows either recent purchases of products related to digital cameras or past purchases that indicate the consumer may need to replace their existing digital camera soon, or (3) from the consumer's browsing history that indicates an interest in the digital camera.

Processor 130 is additionally configured to send a content message 150 to the consumer. Content message 150 includes content stored in content database 120 and located by processor 130. The content included in content message 150 is content associated with a product-of-interest for the consumer. In some embodiments, content message 150 additionally includes product information associated with the product-of-interest and located by the processor 130 in product database 110.

In some embodiments, content message 150 is sent to the consumer without a request from the consumer. In other words, content engine 100 can be configured to provide unsolicited content recommendations via a content message 150 after receiving an indication 140 of interest in an identified product. In other embodiments, content message 150 is sent to the consumer only after a consumer has indicated a desire to receive content messages 150 from the content engine 100. For example, a consumer can indicate a desire to receive content messages 150 by subscribing to a content recommendation service or by accepting previous content messages 150.

Content message 150 may be sent to the consumer in many formats. In one embodiment, content message 150 is an e-mail message that includes links to various online publications and other content associated with the product-of-interest. In other embodiments, content message 150 can be a text message, computer pop-up notification, television pop-up notification, voice message on a phone or voicemail machine, or smart phone alert. In some embodiments, content message 150 includes links to online content rather than the content itself. To ensure timely receipt by a consumer, a content message 150 may also be sent in more than one of these formats, such as a content message 150 sent by both e-mail and text message.

Content message 150 may be sent at various time intervals, either as a push notification or as a batch update. A push notification is distinguished from a batch update in that it occurs on an as-needed basis (i.e.—not at a regularly-scheduled interval) and is likely to include only a single piece of content. A push notification is known to one of skill in the art to generally be sent via a smart-phone pop-up message, a television pop-up message, or a text message, although an e-mail message may also be used. A batch update, on the other hand, occurs at a regular interval—such as weekly—and includes an update of at least a portion of the content received associated with the product-of-interest during the interval.

In some embodiments, content message 150 includes both content and product information. Processor 130 searches within product database 110 for product information associated with the product-of-interest. Once located, this product information may be promulgated in the content message. For example, the content message 150 may include the lowest priced offer for sale, or may include several purchasing options and configurations from various merchants for the consumer to compare.

In some embodiments where content message 150 includes both content and product information, the content may be embedded with optionally selectable links to product information or to the website of a merchant offering the product-of-interest for sale. These optionally selectable links are included either in the content message 150 itself, or in the content contained in content message 150.

Returning again to the example of the digital camera, processor 130 may search product database 110 to locate merchants presently offering the product-of-interest for sale. Processor 130 may then include a link to a specific online merchant's website if that merchant offers the lowest price on the product-of-interest, or may include a series of links to various online merchants' websites allowing a consumer to compare the differing terms and conditions of each offer for sale. For example, one merchant may offer the lowest price, but a second merchant may offer free shipping, and a third merchant may offer a free camera carrying case with the purchase. The consumer is thus able to compare these offers when considering a purchase.

In some embodiments, processor 130 receives a notice 155 from consumer (shown on FIG. 1B) if the consumer selects an optionally selectable link in content message 150 or the content contained in content message 150. This feature allows content engine 100 to monitor and track consumer interest in the content and product information provided to the consumer. This tracking information can then be used to further inform content engine's 100 decision to send certain content to consumers. For example, if a specific item of content is popular with a first segment of consumers, content engine 100 may decide to send it as well to a second segment of consumers. Further, this feature allows content engine 100 to estimate the commercial impact of a content message 150. If a content message 150 includes optionally selectable links to the website of a merchant offering the product-of-interest for sale, then knowing how frequently consumers selected the link and visited the website may be useful in determining commercial traffic driven by content message 150.

In some embodiments, processor 130 includes filters to reduce the volume of content sent to a consumer. These filters may be implemented as a ranking or scoring system based on the relevance of content to the product-of-interest or by similar methods. Where content items are ranked by relevance, only a predetermined number of content items will be sent to a consumer. A filter ensures that only a portion of the located content is included in content message 150. A filter may also be used in a similar manner with product information.

Returning again to the example of the digital camera, if the processor 130 searches content database 120 and locates thousands of items of content associated with the camera, it is not desired to inundate a consumer with thousands of items of content in a content message 150. Processor 130 thus uses filters to cull the located content. A filter may provide each item of content with a discrete score, for example on a scale of 1 to 100, which indicates the strength of the link between the content and the product-of-interest. Processor 130 could then rank the items of content by relevance, and send only a predetermined number of the items of content to the consumer in content message 150.

In some embodiments, the consumer optionally establishes preferences 135 (shown in FIG. 1B) with content engine 100 regarding content message 150. For example, the consumer may establish a set interval for receiving content messages 150, such as daily, weekly, or monthly. The consumer may request that content engine 100 not send any push notifications. The consumer may also request a specific format for sending content message 150, such as by e-mail or text message.

FIG. 1B is a simplified block diagram illustrating in further detail the communications between processor 130 and consumer. A consumer optionally sends preferences 135 to processor 130 regarding content messages 150. A consumer additionally sends an indication of interest 140 in an identified product. Processor 130 sends a content message 150 to consumer. If content message 150 includes optionally selectable links, in some embodiments, consumer sends a notice 155 back to processor 130 if the consumer selects the links. Each of these communications between processor 130 and consumer are discussed in more detail above in connection with FIG. 1A.

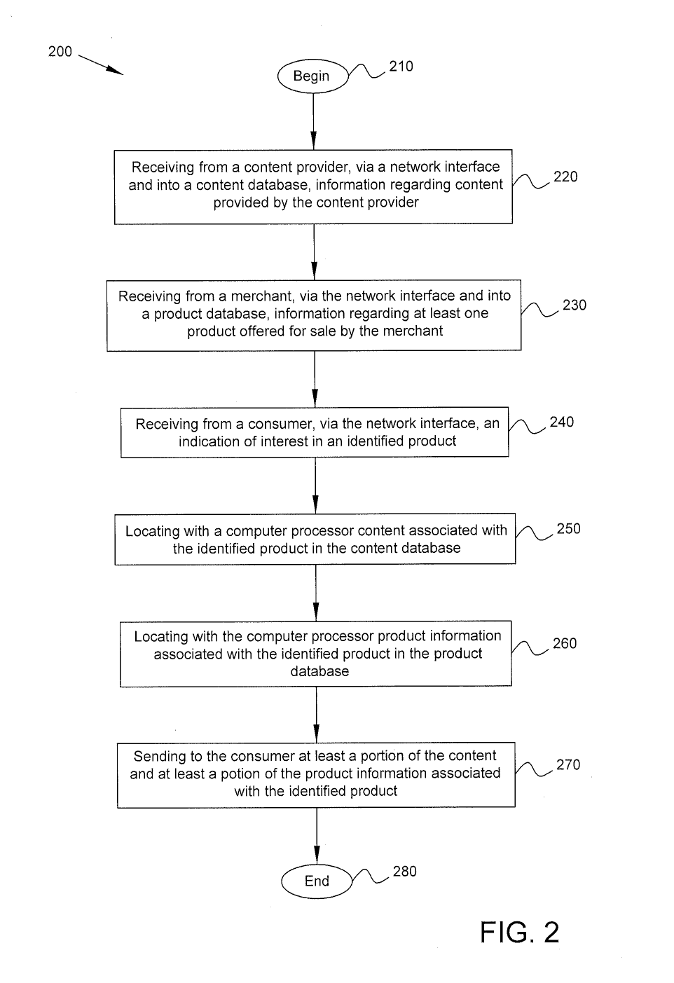

FIG. 2 is a flow diagram of a process 200 in accordance with some embodiments of the present disclosure. The process 200 begins at block 210. At block 220, information regarding content provided by a content provider is received into a content database via a network interface. At block 230, information regarding a product offered for sale by a merchant is received from the merchant into a product database via the network interface. At block 240, an indication of interest in a product is received from a consumer via the network interface. A computer processor then locates content associated with the identified product and product information associated with the identified product at blocks 250 and 260, respectively. At block 270, at least a portion of the located content and product information are sent to the consumer, with or without a request from the consumer. The process 200 ends at block 280.

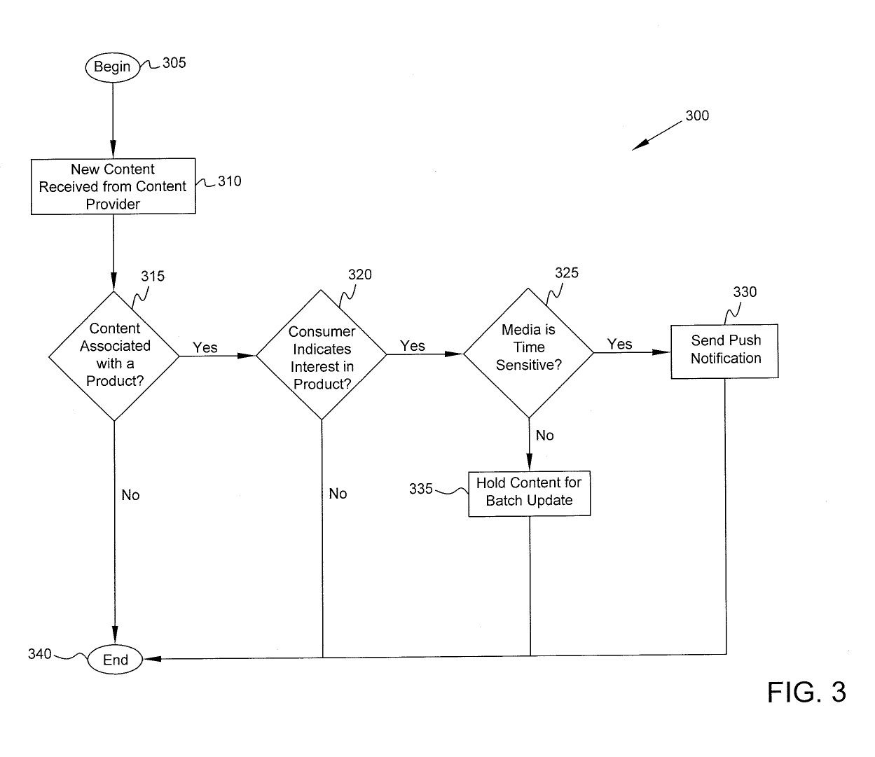

FIG. 3 is a flow diagram of a process used to in-process new content from a content provider. When new content is received from a content provider, it may be desirable to send or ‘push’ this content to a consumer quickly. Examples of time-sensitive content include television shows featuring the product-of-interest that will air in the immediate or near future, and content published to the Internet for a limited time.

The in-processing of new content begins at block 305. At block 310, the new content is received from a content provider. At block 315, new content associated with a product is sent to block 320, while new content that is not associated with any products is sent to the end, block 340. Content that is not associated with any products has no value in the content database and will likely be discarded. At block 320, it is determined if a consumer has indicated interest in the specific product or products associated with the content.

If a consumer has indicated interest in the product associated with the content, then the content is sent to block 325 where it is determined whether the content is time-sensitive. The threshold for determining time-sensitive material may vary depending on (1) the type of product, (2) the type of content, (3) the strength of association between the content and the product-of-interest, and (4) the timing of the content's availability. Calling again upon the example of a digital camera of interest, a television show airing in a few hours that features the camera may be considered time-sensitive, while an Internet publication reviewing the camera's various features may not be considered time-sensitive. Adjusting this threshold for a time-sensitivity determination allows the content engine to send relevant content to a consumer, but likewise prevents the content engine with inundating a consumer with every piece of new content received from a content provider and loosely related to the product-of-interest.

Content that is determined to be time-sensitive is sent to the consumer as a push notification at block 330. Content that is not time-sensitive is held, at block 335, for batch update. A push notification is distinguished from a batch update in that it occurs on an as-needed basis (i.e.—not at a regularly-scheduled interval) and is likely to include only a single piece of content. A push notification is known to one of skill in the art to generally be sent via a smart-phone pop-up message, a television pop-up message, or a text message, although an e-mail message may also be used. A batch update, on the other hand, occurs at a regular interval—such as weekly—and includes an update of at least a portion of the content received associated with the product-of-interest during the interval.

The in-processing of new content received from a content provider ends at block 340.

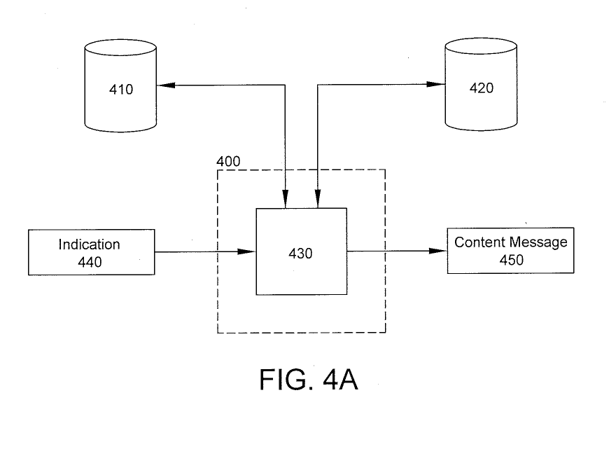

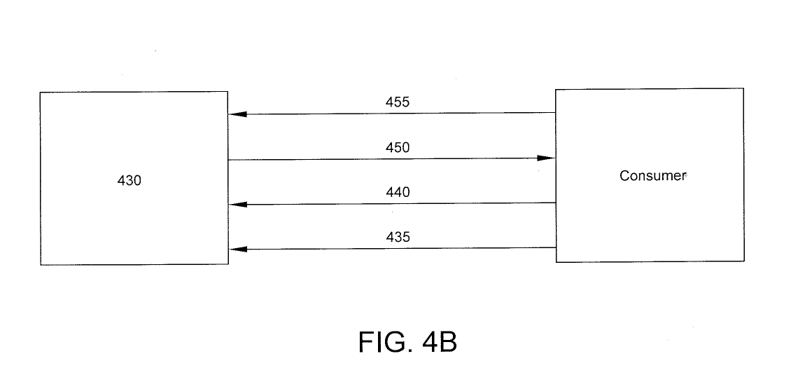

FIG. 4A is a block diagram of an exemplary system in accordance with some embodiments of the present disclosure. FIG. 4A shows a content engine 400 comprising a processor 430 in communication with a product database 410 and content database 420. Although similar in many respects to the embodiment illustrated in FIG. 1A, the embodiment illustrated in FIG. 4A differs at least because product database 410 and content database 420 may be provided by third parties and because indication 440 may be received from entities other than the consumer.

Product database 410 and content database 420 may be provided by third parties; which is to say that the entity operating content engine 400, the entity providing the product database 410, and the entity providing the content database 420 may each be separate and distinct entities.

Product database 410 is configured to receive product information from at least one merchant. Product information may include product name, description, price, dimensions, features, shipping weight, location, manufacturer, availability, and merchant offering the product for sale. Product information is stored in product database 410, which is accessible to processor 430. Product database 410 may be owned, controlled, operated, and maintained by a third party.

Content database 420 is configured to receive content information from at least one content provider. A content provider is generally an entity that publishes content on the Internet, but may also include television and radio broadcasters, print media, and other entities which provide information to the public. Content providers populate content database 420 with information regarding the content, including the type of content (online publication, television, online video, radio, print media, etc.), a brief description of the content, timing of the content (date/time of publication, transmission, viewing), and products associated with the content. Content is stored in content database 420, which is accessible to processor 430. Content database 420 may be owned, controlled, operated, and maintained by a third party.

With specific regard to the strength of association between content and a product, the content provider may provide this strength of association, or the processor 430 may determine the strength of association. The strength of association may be implemented as a scale, for example from 0 to 100, wherein a high degree of association receives a higher score on the scale. For example, content such as an article reviewing a product would receive a higher strength of association score than a television show making a passing reference to the product. In some embodiments, the strength of association is provided by the content provider and adjusted for consistency across all content by the content engine 400. As is discussed below, the strength of association may be used in some embodiments to filter content prior to sending a content message 450.

Processor 430 is a computer processor that includes a non-transitory computer readable medium encoded with data and instructions for the various processing steps required in the present disclosure. Processor 430 is configured to communicate, either directly or via a network interface, with product database 410 and content database 420. Processor is further configured to receive, via a network interface, indication 440 and to send, again via a network interface, a content message 450.

Indication 440 is a consumer's indication of interest in a product. Indication 440 can be received by numerous entities, such as the consumer, a merchant's website, a financial services institution, or any other entity able to discern a consumer's potential interest in a product.

In some embodiments, indication 440 is received when a consumer adds a product to a ‘Wish List’—a list available with many online merchants that allows a consumer to track products the consumer would like to purchase. The present disclosure posits the act of adding a product to a ‘Wish List’ is a direct indication of a consumer's interest in a product. Processor 430 is configured to receive, via a network interface, indication 440 once the consumer has added a product to their ‘Wish List.’

In other embodiments, indication 440 is received from the consumer or from other entities based on the consumer's purchase history or Internet browsing history. A consumer's purchase history may be obtained directly from the consumer, from the consumer's web browser using a purchase tracker, from a third party merchant, or from a third party financial service, such as a credit card company or online payment system provider. Purchase and browsing history can be reviewed by processor 430 to evaluate a consumer's predicted level of interest in various content and to identify products of potential or probable interest to the consumer. Purchase and browsing history may also be reviewed by a third party, with any resulting indications of potential interest in an identified product then sent to processor 430.

Processor 430 is additionally configured to send a content message 450 to the consumer. Content message 450 includes content stored in content database 420 and located by processor 430. The content included in content message 450 is content associated with a product-of-interest for the consumer. In some embodiments, content message 450 additionally includes product information associated with the product-of-interest and located by the processor 430 in product database 410.

In some embodiments, content message 450 can be sent to the consumer without a request from the consumer. In other words, content engine 400 can be configured to provide unsolicited content recommendations via a content message 450 after receiving an indication 440 of interest in an identified product. In other embodiments, content message 450 is sent to the consumer only after a consumer has indicated a desire to receive content messages 450 from the content engine 400. For example, a consumer can indicate a desire to receive content messages 450 by subscribing to a content recommendation service or by accepting previous content messages 450.

Content message 450 may be sent to the consumer in many formats. In one embodiment, content message 450 is an e-mail message that includes links to various online publications and other content associated with the product-of-interest. In other embodiments, content message 450 can be a text message, computer pop-up notification, television pop-up notification, voice message on a phone or voicemail machine, or smart phone alert. In some embodiments, content message 450 includes links to online content rather than the content itself. To ensure timely receipt by a consumer, a content message 450 may also be sent in more than one of these formats, such as a content message 450 sent by both e-mail and text message.

Content message 450 may be sent at various time intervals, either as a push notification or as a batch update. A push notification is distinguished from a batch update in that it occurs on an as-needed basis (i.e.—not at a regularly-scheduled interval) and is likely to include only a single piece of content. A push notification is known to one of skill in the art to generally be sent via a smart-phone pop-up message, a television pop-up message, or a text message, although an e-mail message may also be used. A batch update, on the other hand, occurs at a regular interval—such as weekly—and includes an update of at least a portion of the content received associated with the product-of-interest during the interval.

In some embodiments, content message 450 includes both content and product information. Processor 430 searches within product database 410 for product information associated with the product-of-interest. Once located, this product information may be promulgated in the content message. For example, the content message 450 may include the lowest priced offer for sale, or may include several purchasing options and configurations from various merchants for the consumer to compare.

In some embodiments where content message 450 includes both content and product information, the content may be embedded with optionally selectable links to product information or to the website of a merchant offering the product-of-interest for sale. These optionally selectable links are included either in the content message 450 itself, or in the content contained in content message 450.

In some embodiments, processor 430 receives a notice 455 if the consumer selects an optionally selectable link in content message 450 (shown in FIG. 4B) or the content contained in content message 450. This feature allows content engine 400 to monitor and track consumer interest in the content and product information provided to the consumer. This tracking information can then be used to further inform content engine's 400 decision to send certain content to consumers. For example, if a specific item of content is popular with a first segment of consumers, content engine 400 may decide to send it as well to a second segment of consumers. Further, this feature allows content engine 400 to estimate the commercial impact of a content message 450. If a content message 450 includes optionally selectable links to the website of a merchant offering the product-of-interest for sale, then knowing how frequently consumers selected the link and visited the website may be useful in determining commercial traffic driven by content message 450.

In some embodiments, processor 430 includes filters to reduce the volume of content sent to a consumer. These filters may be implemented as a ranking or scoring system based on the relevance of content to the product-of-interest or by similar methods. Where content items are ranked by relevance, only a predetermined number of content items will be sent to a consumer. A filter ensures that only a portion of the located content is included in content message 450. A filter may also be used in a similar manner with product information.

In some embodiments, the consumer optionally establishes preferences 435 (shown in FIG. 4B) with processor 430 regarding content message 450. For example, the consumer may establish a set interval for receiving content messages 450, such as daily, weekly, or monthly. The consumer may request that content engine 400 not send any push notifications. The consumer may also request a specific format for sending content message 450, such as by e-mail or text message.

FIG. 4B is a simplified block diagram illustrating in further detail the communications between processor 430 and consumer. A consumer optionally sends preferences 435 to processor 430 regarding content messages 450. A consumer may additionally send an indication 440 of interest in an identified product. It is important to note that in the embodiment illustrated in FIGS. 4A and 4B, indication 440 may also be received at processor 430 from a third party, or a party that is separate and distinct from the consumer. Processor 430 sends a content message 450 to consumer. If content message 450 includes optionally selectable links, in some embodiments a notice 455 is sent back to processor 430 if a consumer selects the links. Each of these communications between processor 430 and consumer is discussed in more detail above in connection with FIG. 4A.

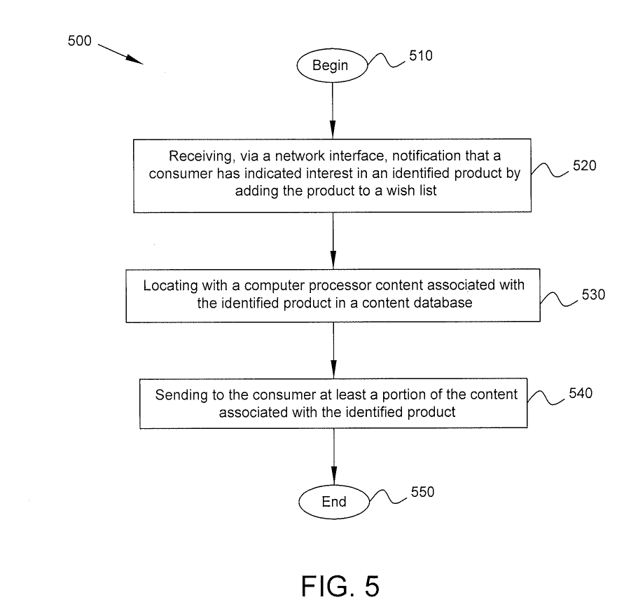

FIG. 5 is a flow diagram of a process 500 in accordance with some embodiments of the present disclosure. The process 500 begins at block 510. At block 520 a notification is received at a content engine that a consumer has added a product to their wish list, indicating interest in the identified product. At block 530, a computer processor locates content associated with the identified product in a content database. At least a portion of this located content associated with the identified product can be sent to the consumer with or without a request from the consumer at block 540. The process 500 ends at block 550.

It is understood by those familiar with the art that the system described herein may be implemented in hardware, firmware, or software encoded on a non-transitory computer-readable storage medium.

The previous description of the embodiments is provided to enable any person skilled in the art to practice the disclosure. The various modifications to these embodiments will be readily apparent to those skilled in the art, and the generic principles defined herein may be applied to other embodiments without the use of inventive faculty. Thus, the present disclosure is not intended to be limited to the embodiments shown herein, but is to be accorded the widest scope consistent with the principles and novel features disclosed herein.

What is claimed is:

1. A method of identifying and sending content to a consumer comprising:
receiving, via a network interface, notification that a consumer has indicated interest in an identified product by adding the product to a wish list;
locating with a computer processor content associated with the identified product in a content database; and
sending to the consumer, without a request from the consumer, at least a portion of the content associated with the identified product.

2. The method of claim 1 wherein the at least a portion of the content associated with the identified product is sent as a push notification.

3. The method of claim 1 wherein the at least a portion of the content associated with the identified product is sent as a batch update.

4. The method of claim 1 further comprising:
locating with a computer processor product information associated with the identified product in a product database; and
sending to the consumer, without a request from the consumer, at least a portion of the product information associated with the identified product.

5. The method of claim 4 wherein the at least a portion of the content and the at least a portion of the product information are sent to the consumer in a single message.

6. The method of claim 5 further comprising:
receiving preferences from the consumer, including at least a format and timing, for sending the at least a portion of the content and the at least a portion of the product information associated with the identified product.

7. The method of claim 3 wherein the content associated with the identified product is sent to the consumer in one of the following formats: electronic mail, text message, computer pop-up notification, television pop-up notification, voice message, or smart phone alert.

8. The method of claim 5 wherein the content associated with the identified product, when viewed by the consumer, includes an optionally selectable link to the website of an online merchant offering the identified product for sale.

9. A method of identifying and sending content to a consumer comprising:
receiving from a content provider, via a network interface and into a content database, information regarding content provided by the content provider;
receiving from a merchant, via the network interface and into a product database, information regarding at least one product offered for sale by the merchant;
receiving from a consumer, via the network interface, an indication of interest in an identified product;
locating with a computer processor content associated with the identified product in the content database;
locating with the computer processor product information associated with the identified product in the product database; and
sending to the consumer at least a portion of the content and at least a portion of the product information associated with the identified product.

10. The method of claim 9 wherein the indication of interest in the identified product is received from at least one of:
an addition of a product to a wish list of the consumer;
a browsing history of the consumer; and
a purchasing history of the consumer.

11. The method of claim 10 further comprising:
receiving from the consumer preferences, including at least a format and timing, for sending the at least a portion of the content and the at least a portion of the product information associated with the identified product.

12. The method of claim 11 wherein the content associated with the identified product is sent to the consumer in one of the following formats: electronic mail, text message, computer pop-up notification, television pop-up notification, voice message, or smart phone alert.

13. The method of claim 12 wherein the content associated with the identified product, when viewed by the consumer, includes optionally selectable links to the product information associated with the identified product.

14. The method of claim 13 further comprising:
receiving a notification if the consumer selects the optionally selectable link to view the product information.

15. A method of identifying and sending content to a consumer comprising:
receiving, from a content provider, into a content database:
a description of content which contains a reference to an identified product;
a rating of the strength of the reference to the identified product;
a location of the content;
monitoring a plurality of wish lists, each wish list associated with one of a plurality of consumers;
locating, after the identified product is added to one of the plurality of wish lists, content which contains a reference to an identified product; and
sending the content which contains a reference to an identified product to a consumer associated with each of the plurality of wish lists to which the identified product was added.

16. The method of claim 15, wherein the content is sent in one of the following formats: electronic mail, text message, computer pop-up notification, television pop-up notification, voice message, or smart phone alert.

17. The method of claim 16, wherein the content associated with the identified product, when viewed by the consumer, includes optionally selectable links to the webpage of a merchant selling the identified product.

18. The method of claim 17 further comprising:
receiving a notification if the consumer selects the optionally selectable link to view the product information.

19. A system of identifying and sending content to a consumer comprising:
a content database, populated with information provided by a content provider;
a product database, populated with information provided by a merchant;
at least one processor, the at least one processor configured to:
receive a notification that a consumer has added an identified product to an online wish list associated with the consumer;
locate in the content database content associated with the identified product;
locate in the product database product information associated with the identified product; and
a communication element for transmitting to the consumer at least a portion of the content and at least a portion of the product information associated with the identified product.

20. The system of claim 19 wherein the communication element transmits to the consumer in at least one of the following formats: electronic mail, text message, computer pop-up notification, television pop-up notification, voice message, or smart phone alert.

21. The system of claim 20, the at least one processor additionally configured to:
receive from the consumer preferences, including at least a format and timing, for sending the at least a portion of the content and the at least a portion of the product information associated with the identified product.

22. The system of claim 21, wherein the at least a portion of the content associated with the identified product includes optionally selectable links to the webpage of a merchant selling the identified product.

23. The system of claim 22, the at least one processor additionally configured to:
receive a notification if the consumer selects the optionally selectable link to view the product information.

24. A method of identifying and sending content and product information to a consumer comprising:
receiving from a content provider, via a network interface and into a content database, information regarding content provided by the content provider;
receiving from a merchant, via the network interface and into a product database, information regarding at least one product offered for sale by the merchant;
receiving from a consumer, via the network interface, an indication of interest in an identified product by the consumer adding the identified product to an online wish list;
locating with a computer processor in the content database content associated with the identified product;
locating with the computer processor in the product database product information associated with the identified product;
receiving from the consumer preferences regarding a method and timing for sending at least a portion of the content and at least a portion of product information associated with the identified product; and
sending to the consumer the at least a portion of the content and the at least a portion of the product information associated with the identified product.

25. A non-transitory computer readable medium encoded with data and instructions, when executed by a computing device the instructions causing the computer device to:
receive, via a network interface, notification that a consumer has indicated interest in an identified product by adding the product to a wish list;
locate with a computer processor content associated with the identified product in a content database; and
send to the consumer, without a request from the consumer, at least a portion of the content associated with the identified product.

26. A non-transitory computer readable medium encoded with data and instructions, when executed by a computing device the instructions causing the computer device to:
receive from a content provider, via a network interface and into a content database, information regarding content provided by the content provider;
receive from a merchant, via the network interface and into a product database, information regarding at least one product offered for sale by the merchant;
receive from a consumer, via the network interface, an indication of interest in an identified product;
locate content associated the identified product in the content database;
locate product information associated with the identified product in the product database; and
send to the consumer, without a request from the consumer, at least a portion of the content and at least a portion of the product information associated with the identified product.

27. A non-transitory computer readable medium encoded with data and instructions, when executed by a computing device the instructions causing the computer device to:
receive from a content provider, via a network interface and into a content database, information regarding content provided by the content provider;
receive from a merchant, via the network interface and into a product database, information regarding at least one product offered for sale by the merchant;
receive from a consumer, via the network interface, an indication of interest in an identified product by the consumer adding the identified product to an online wish list;
locate with a computer processor in the content database content associated with the identified product;
locate with the computer processor in the product database product information associated with the identified product;
receive from the consumer preferences regarding a method and timing for sending at least a portion of the content and at least a portion of product information associated with the identified product; and
send to the consumer the at least a portion of the content and the at least a portion of the product information associated with the identified product.
